(19) United States
(12) Patent Application Publication
(10) Pub. No.: US 2014/0285473 A1
(43) Pub. Date: Sep. 25, 2014

(54) ELECTRONIC WHITE BOARD SYSTEM, ELECTRONIC STYLUS AND WRITING METHOD

(71) Applicant: HON HAI PRECISION INDUSTRY CO., LTD., New Taipei (TW)

(72) Inventor: JEN-TSORNG CHANG, New Taipei (TW)

(73) Assignee: HON HAI PRECISION INDUSTRY CO., LTD., New Taipei (TW)

(21) Appl. No.: 14/225,374

(22) Filed: Mar. 25, 2014

(30) Foreign Application Priority Data
Mar. 25, 2013 (TW) 102110415

(51) Int. Cl. G06F 3/0354; G06F 3/042

(52) U.S. Cl. CPC G06F 3/03545; G06F 3/0421
USPC 345/175

(57) ABSTRACT

An electronic stylus is configured for writing on an electronic white board. A color of a surface of the electronic stylus is corresponding with a writing color of the electronic stylus. The electronic stylus comprises a sensing hole, an optical sensing module, and a signal output module. The sensing hole is defined through a side wall of the electronic stylus. The optical sensing module and the signal output module are arranged in the electronic stylus and face the sensing hole. The optical sensing module is configured for generating a blocking signal representing the writing color of the electronic stylus when the first sensing hole is blocked. The signal output module is configured for sending out the blocking signal. The present disclosure also relates to an electronic white board system and a writing method.

### BACKGROUND

1. Technical Field

The present disclosure relates to writing boards, and particularly to an electronic white board system, a plurality of electronic styluses and a writing method.

2. Description of Related Art

At present, electronic white boards are typically written on using electronic stylus. A color writing is achieved by choosing different colors on an input menu of the electronic white board, which is inconvenient. Therefore, it is desirable to provide an electronic white board system, a plurality of electronic styluses and a writing method that can overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an embodiment of an electronic white board system.

FIG. 2 is a top view of a white board eraser of the electronic white board system in FIG. 1.

FIG. 3 is a block diagram of an electronic writing module of the electronic white board system in FIG. 1.

FIG. 4 is a block diagram of an electronic removing module of the electronic white board system in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

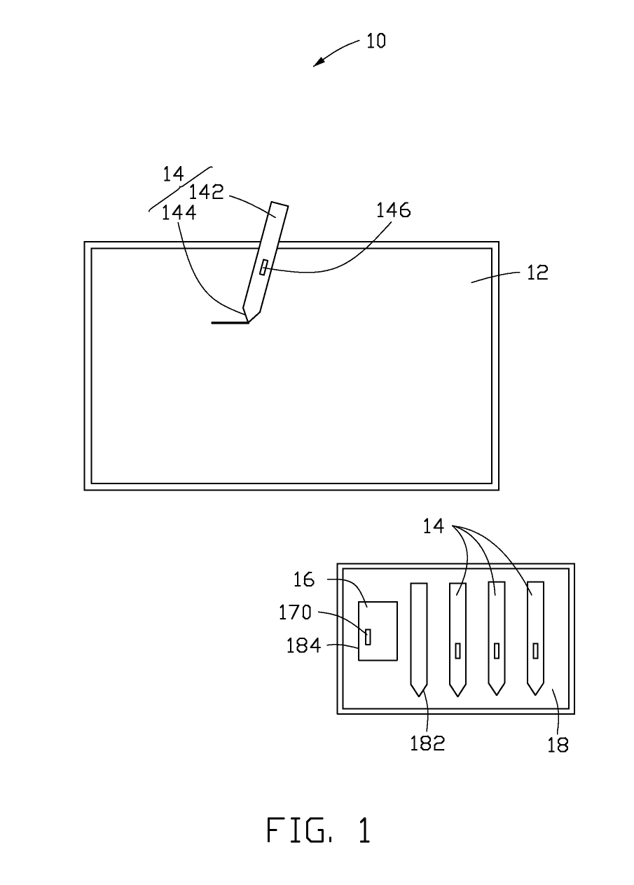

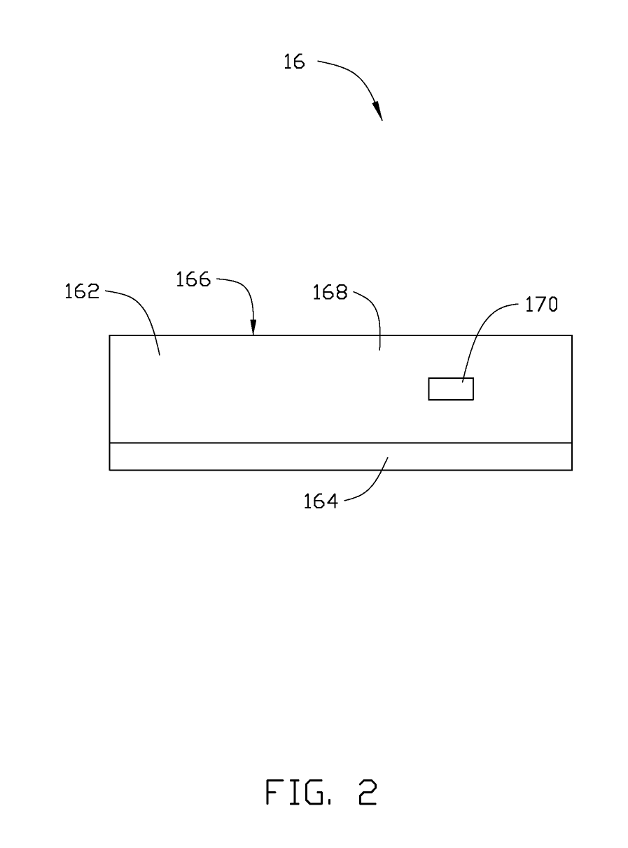

FIGS. 1-4 show an electronic white board system 10 according to a first embodiment. The electronic white board system 10 includes an electronic white board 12, a plurality of electronic styluses 14, a white board eraser 16, and a base 18. The electronic white board 12, the electronic styluses 14, and the base 18 are defined to be an electronic writing module. The electronic white board 12, the white board eraser 16, and the base 18 are defined to be an electronic removing module.

The electronic styluses 14 are configured for writing in different colors on the electronic white board. Each electronic stylus 14 includes a penholder 142 with stick-shape and a writing head 144 connecting on one end of the penholder 142. In this embodiment, the penholder 142 has a hollow structure. A first sensing hole 146 is defined through a side wall of the penholder 142. In this embodiment, the writing head 144 is tapered.

Colors of surfaces of different electronic styluses 14 are different. Writing colors of different electronic styluses 14 are also different. The color of the surface of each electronic stylus 14 is corresponding with the writing color of the electronic stylus 14. In this embodiment, the number of the electronic styluses 14 is four. Colors of surfaces of the electronic styluses 14 are red, blue, orange, and purple respectively. It is to be understood that, entire surface of the electronic stylus 14 can be a color corresponding to the writing color, or a part surface of the electronic stylus 14 can be a color corresponding to the writing color. For example, the surface of the penholder 142 can be a color corresponding to the writing color of the electronic stylus 14, or the surface of the writing head 144 can be a color corresponding to the writing color of the electronic stylus 14, or entire surface of the electronic stylus 14 can be a color corresponding to the writing color of the electronic stylus 14.

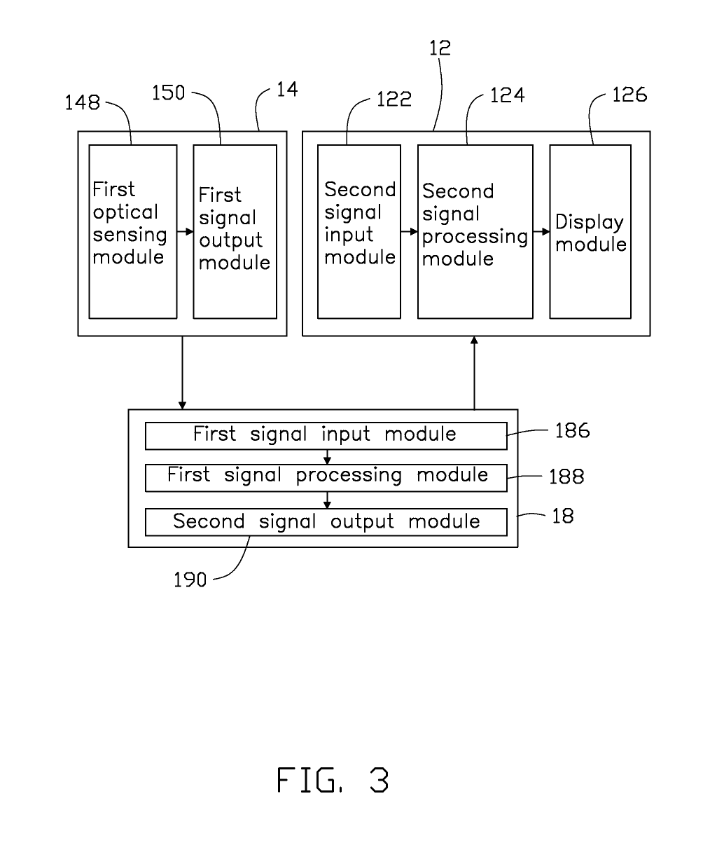

FIG. 3 shows that each electronic stylus 14 further includes a first optical sensing module 148 and a first signal output module 150. The first optical sensing module 148 and the first signal output module 150 are arranged in the penholder 142. The first optical sensing module 148 faces the first sensing hole 146. When the first sensing hole 146 is blocked, the first optical sensing module 148 gets information by sensing light intensity change and generating a blocking signal representing the writing color of the electronic stylus 14. The first signal output module 150 is configured for sending out the blocking signal.

The white board eraser 16 is configured for contacting with the electronic white board 12 and removing the writings, such as characters and figures, written by the electronic stylus 14 on the electronic white board 12. The white board eraser 16 includes a holder 162 with plate-shaped and a clean portion 164 connected to and be covered by the holder 162. In this embodiment, the thickness of the holder 162 is greater than that of the clean portion 164. The holder 162 includes a top surface 166 away from the clean portion 164 and a side surface 168 connected to the top surface 166. One second sensing hole 170 is defined in the top surface 166, and another sensing hole 170 is defined in the side surface 168.

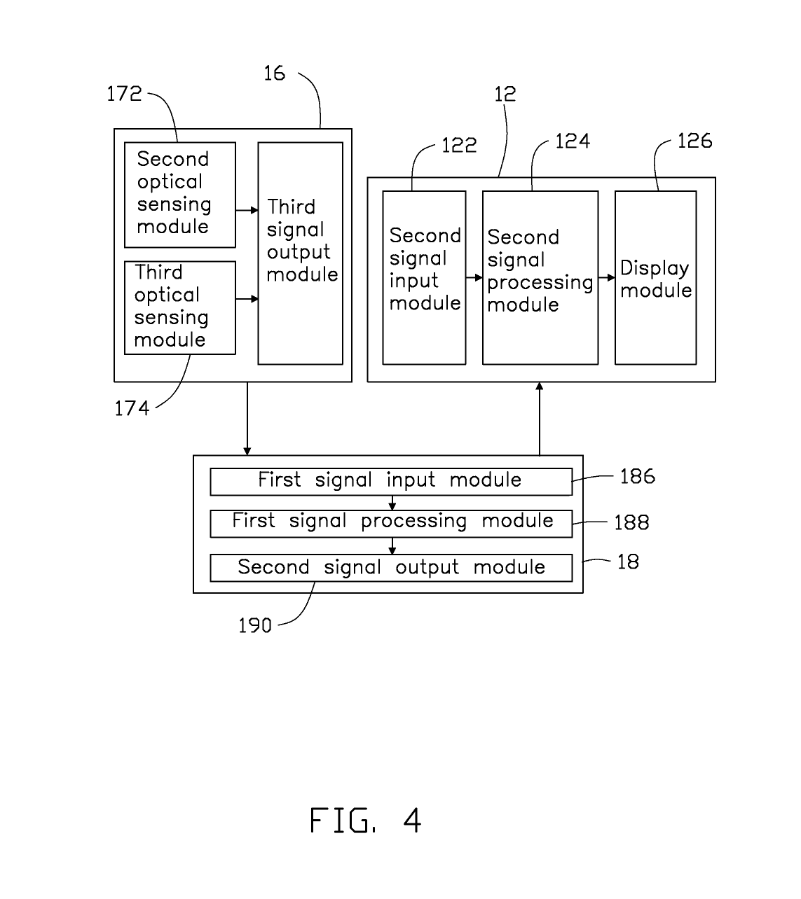

FIG. 4 shows that the white board eraser 16 further includes a second optical sensing module 172, a third optical sensing module 174, and a third signal output module 176. The second optical sensing module 172, the third optical sensing module 174 and the third signal output module 176 are all arranged in the holder 162. The second optical sensing module 172 faces the second sensing hole 170 defined in the top surface 166. The third optical sensing module 174 faces the second sensing holes 170 defined in the side surface 168. When the second sensing holes 170 are blocked, the second optical sensing module 172 and the third optical sensing module 174 get information by sensing light intensity change and generating a blocking signal representing the white board eraser 16. The third signal output module 176 is configured for sending out the blocking signal.

The base 18 is configured for receiving the electronic styluses 14 and the white board eraser 16. In this embodiment, the base 18 is rectangular-shaped. A plurality of stylus-grooves 182 and an eraser-groove 184 are defined in the base 18. When not being used, the electronic styluses 14 are spatially corresponding to and received in the stylus-grooves 182, and the first sensing holes 146 are exposed from the base 18. The white board eraser 16 is received in the eraser-groove 184, and the second sensing holes 170 are exposed from the base 18, when not being used.

The base 18 further includes a first signal input module 186, a first signal processing module 188, and a second signal output module 190. The first signal input module 186 is configured for receiving the blocking signal sent from the electronic stylus 14 and the white board eraser 16, and transferring the blocking signal to the first signal processing module 188. The first signal processing module 188 is configured for processing the blocking signal sent from the first signal input module 186, and determining whether each blocking signal is sent from the electronic stylus 14 or from the white board eraser 16. If the blocking signal is sent from the electronic stylus 14, the first signal processing module 188 is configured for determining the writing color of the electronic stylus 14 based on the blocking signal, then generating an identification signal representing the writing color of the electronic stylus 14 and sending the identification signal to the second signal output module 190. If the blocking signal is sent from the white board eraser 16, the first signal processing module 188 is configured for generating an identification signal representing the white board eraser 16 and sending the identification signal to the second signal output module 190. The second signal output module 190 is configured for transferring the identification signal to the electronic white board 12.

A light source (not shown) is arranged in the electronic white board 12. The light source is configured for emitting light covering the electronic white board 12. The electronic white board 12 includes a second signal input module 122, a second signal processing module 124, and a display module 126. The second signal input module 122 is configured for receiving the identification signal sent from the second signal output module 190. The second signal processing module 124 is configured for generating a writing color displaying instruction or a removing instruction based on the identification signal, and sending the writing color displaying instruction or the removing instruction to the display module 126. The display module 126 is configured for displaying writing on the electronic white board 12 in the writing color based on the writing color displaying instruction, or removing the writing on the electronic white board 12 based on the removing instruction.

The first signal output module 150, the second signal output module 190, the third signal output module 176, the first signal input module 186, and the second signal input module 122 can be ZigBee module, Bluetooth module, or Wi-Fi module.

FIGS. 1 and 3 show that a writing method used with the above electronic white board system 10 according to a second embodiment includes the following steps.

In step 1, an electronic stylus 14 is chosen. For example, an electronic stylus 14 with a red colored surface is chosen when a red writing color is needed to display on the electronic white board 12.

In step 2, the electronic stylus 14 is held and an entire or part of the first sensing hole 146 is manually blocked. Therefore, the first optical sensing module 148 generates a blocking signal representing the writing color of the electronic stylus 14. In this embodiment, the blocking signal is a red writing color of the electronic stylus 14. Then, the first signal output module 150 transfers the blocking signal to the first signal input module 186. The first signal processing module 188 determines the writing color of the electronic stylus 14 to be red based on the blocking signal, and then generates an identification signal representing the red writing color, and sends the identification signal to the second signal output module 190. Thereafter, the second signal output module 190 transfers the identification signal to the second signal input module 122 of the electronic white board 12. The second signal processing module 124 generates a red writing color displaying instruction based on the identification signal, and sends the red writing color displaying instruction to the display module 126.

In step 3, the electronic stylus 14 is written on the electronic white board 12 by being held, the display module 126 displays the writing in red color based on the red writing color displaying instruction.

FIGS. 1 and 4 show that the writing method further includes the following steps.

In step 4, the white board eraser 16 is chosen. The white board eraser 16 is held and the second sensing holes 170 are manually blocked. Therefore, the second optical sensing module 172 and the third optical sensing module 174 generate a blocking signal representing the white board eraser 14. Then, the third signal output module 176 transfers the blocking signal to the first signal input module 186. The first signal processing module 188 determines the blocking signal belongs to the white board eraser 14, and sends a identification signal representing white board eraser 14 to the second signal output module 190. Thereafter, the second signal output module 190 transfers the identification signal to the second signal input module 122 of the electronic white board 12. The second signal processing module 124 generates a removing instruction based on the identification signal, and sends the removing instruction to the display module 126.

In step 5, the white board eraser 16 is moved on the electronic white board 12 by being held, the display module 126 removes the writing on the electronic white board 12 based on the removing instruction.

Since the number of the second sensing holes 170 is different than that of the first sensing hole 146, the blocking signal representing the writing color of the electronic stylus 14 can be easily differentiated with the blocking signal representing the white board eraser 14 by the number of holes. The number of the second sensing holes 170 can also be one or more than two. The optical sensing module can differentiate the blocking signal representing the writing color of the electronic stylus 14 and the blocking signal representing the white board eraser 14 by determining whether the blocking signal is from the electronic stylus 14 or from the white board eraser 14.

A needed writing color of each electronic stylus 14 can be easily chosen which is convenient.

It is to be understood that the above-described embodiment is intended to illustrate rather than limit the embodiments. Variations may be made to the embodiment without departing from the spirit of the disclosure as claimed. The above-described embodiments are intended to illustrate the scope of the disclosure and not restrict the scope of the embodiments.

What is claimed is:

1. An electronic stylus, configured for writing on an electronic white board, a color of a surface of the electronic stylus being corresponding with a writing color of the electronic stylus, the electronic stylus comprising:
a first sensing hole defined through a side wall of the electronic stylus;
a first optical sensing module arranged in the electronic stylus, the first optical sensing module facing the first sensing hole, the first optical sensing module configured for generating a blocking signal representing the writing color of the electronic stylus when the first sensing hole being blocked; and
a first signal output module arranged in the electronic stylus, the first signal output module configured for sending out the blocking signal.

2. The electronic stylus of claim 1, further comprising a penholder and a writing head connecting on one end of the penholder, a surface of the penholder, a surface of the writing head, or entire surface of the electronic stylus being a color corresponding to the writing color of the electronic stylus.

3. The electronic stylus of claim 2, wherein the penholder has a hollow structure, the first sensing hole defined through a side wall of the penholder, the first optical sensing module and the first signal output module arranged in the penholder.

4. The electronic stylus of claim 3, wherein the penholder is stick-shape, and the writing head is tapered.

5. The electronic stylus of claim 1, wherein the first signal output module is one selected from the group consisting of ZigBee module, Bluetooth module, and Wi-Fi module.

6. An electronic white board system, comprising:
a plurality of electronic styluses, a color of a surface of each electronic stylus being corresponding with a writing color of the electronic stylus, the writing color of different electronic stylus being different, each electronic stylus comprising:
a first sensing hole defined through a side wall of the electronic stylus;
a first optical sensing module arranged in the electronic stylus, the first optical sensing module facing the first sensing hole, the first optical sensing module configured for generating a blocking signal representing the writing color of the electronic stylus when the first sensing hole being blocked; and
a first signal output module arranged in the electronic stylus, the first signal output module configured for sending out the blocking signal;
a base configured for receiving the electronic styluses, comprising:
a first signal input module configured for receiving blocking signal sent from the first signal output module of the electronic stylus;
a first signal processing module configured for processing the blocking signal sent from the first signal input module, and generating a identification signal representing the writing color of the electronic stylus; and
a second signal output module configured for sending out the identification signal; and
an electronic white board configured for generating writing in a color according to the writing color of the electronic stylus after the electronic stylus moved whereon, the electronic white board comprising:
a second signal input module configured for receiving the identification signal sent from the second signal output module;
a second signal processing module configured for generating a writing color displaying instruction based on the identification signal, and sending out the writing color displaying instruction; and
a display module configured for displaying writing in the writing color on the electronic white board based on the writing color displaying instruction.

7. The electronic white board system of claim 6, further comprising a white board eraser configured for removing the writing on the electronic white board written by the electronic styluses, the white board eraser comprising:
a second sensing hole;
a second optical sensing module facing the second sensing hole, the second optical sensing module configured for generating a blocking signal representing the white board eraser when the second sensing hole being blocked; and
a third signal output module configured for transferring the blocking signal sent from the second optical sensing module to the first signal input module of the base;
wherein the first signal input module also configured for receiving blocking signal sent from the third signal output module of the white board eraser, the first signal processing module also configured for generating a identification signal representing the white board eraser, the second signal processing module also configured for generating a removing instruction based on the identification signal, and sending out the removing instruction, the display module also configured for removing the writing based on the removing instruction.

8. The electronic white board system of claim 7, wherein the white board eraser comprises a holder and a clean portion connected to and be covered by the holder, The holder comprising a top surface away from the clean portion and a side surface connected to the top surface, the second sensing hole defined in the top surface.

9. The electronic white board system of claim 8, wherein the white board eraser further comprises another second sensing hole and a third optical sensing module, the another second sensing hole defined in the side surface, the third optical sensing module facing the second sensing holes defined in the side surface, the third optical sensing module configured for getting information about the second sensing hole defined in the side surface being blocked, and generating a blocking signal representing the white board eraser.

10. The electronic white board system of claim 9, wherein the first signal output module, the second signal output module, the third signal output module, the first signal input module, and the second signal input module are one selected from the group consisting of ZigBee module, Bluetooth module, and Wi-Fi module.

11. The electronic white board system of claim 7, further comprising a penholder and a writing head connecting on one end of the penholder, a surface of the penholder, a surface of the writing head, or entire surface of the electronic stylus being a color corresponding to the writing color of the electronic stylus.

12. The electronic white board system of claim 11, wherein the penholder has a hollow structure, the first sensing hole defined through a side wall of the penholder, the first optical sensing module and the first signal output module arranged in the penholder.

13. The electronic white board system of claim 11, wherein the penholder is stick-shape, and the writing head is tapered.

14. A writing method, using an electronic white board system; the electronic white board system comprising a plurality of electronic styluses, a base, and an electronic white board; a color of a surface of each electronic stylus being corresponding with a writing color of the electronic stylus, the writing color of different electronic stylus being different, each electronic stylus comprising a first sensing hole, a first optical sensing module, and a first signal output module, the first sensing hole defined through a side wall of the electronic stylus, the first optical sensing module arranged in the electronic stylus, the first optical sensing module facing the first sensing hole, the first optical sensing module configured for generating a blocking signal representing the writing color of the electronic stylus when the first sensing hole being blocked, the first signal output module arranged in the electronic stylus, the first signal output module configured for sending out the blocking signal; the base configured for receiving the electronic styluses, the base comprising a first signal input module, a first signal processing module and a second signal output module, the first signal input module configured for receiving blocking signal sent from the first signal output module of the electronic stylus, the first signal processing module configured for processing the blocking signal sent from the first signal input module, and generating a identification signal representing the writing color of the electronic stylus, the second signal output module configured for sending out the identification signal, the electronic white board configured for generating writing in a color according to the writing color of the electronic stylus after the electronic stylus moved whereon; the electronic white board comprising a second signal input module, a second signal processing module and a display module, the second signal input module configured for receiving the identification signal sent from the second signal output module, the second signal processing module configured for generating a writing color displaying instruction based on the identification signal, and sending out the writing color displaying instruction, the display module configured for displaying writing in the writing color on the electronic white board based on the writing color displaying instruction; the writing method comprising:
the electronic stylus is chosen;
the electronic stylus being held, and an entire or part of the first sensing hole being manually blocked, therefore, the first optical sensing module generating a blocking signal representing the writing color of the electronic stylus, then, the first signal output module transfers the blocking signal to the first signal input module, the first signal processing module determining the writing color of the electronic stylus, and sending an identification signal representing the writing color to the second signal output module, thereafter, the second signal output module transferring the identification signal to the second signal input module of the electronic white board, the second signal processing module generating a writing color displaying instruction based on the identification signal, and sending the writing color displaying instruction to the display module; and
the electronic stylus written on the electronic white board by being held, and, the display module displaying the writing in the writing color based on the writing color displaying instruction.

15. The writing method of claim 14, wherein the electronic white board system further comprises a white board eraser; the white board eraser configured for removing the writing on the electronic white board written by the electronic styluses, the white board eraser comprising a second sensing hole, a second optical sensing module, and a third signal output module, the second optical sensing module facing the second sensing hole, the second optical sensing module configured for generating a blocking signal representing the white board eraser when the second sensing hole being blocked, the third signal output module configured for transferring the blocking signal sent from the second optical sensing module to the a first signal input module of the base; the first signal input module also configured for receiving blocking signal sent from the third signal output module of the white board eraser, the first signal processing module also configured for generating a identification signal representing the white board eraser, the second signal processing module also configured for generating a removing instruction based on the identification signal, and sending out the removing instruction, the display module also configured for removing the writing based on the removing instruction; the writing method further comprising:
the white board eraser being chosen;
the white board eraser being held and the second sensing hole being manually blocked, therefore, the second optical sensing module generating a blocking signal representing the white board eraser and sending the blocking signal to the third signal output module, then, the third signal output module transferring the blocking signal to the first signal input module, the first signal processing module determining the blocking signal belong to the white board eraser, and sending a identification signal representing white board eraser to the second signal output module, thereafter, the second signal output module transferring the identification signal to the second signal input module of the electronic white board, the second signal processing module generating a removing instruction based on the identification signal, and sending the removing instruction to the display module; and
the white board eraser moved on the electronic white board by being held, and, the display module removing the writing of the electronic stylus based on the removing instruction.

16. The writing method of claim 15, wherein the white board eraser comprises a holder and a clean portion connected to and be covered by the holder, The holder comprising a top surface away from the clean portion and a side surface connected to the top surface, the second sensing hole defined in the top surface.

17. The writing method of claim 16, wherein the white board eraser further comprises another second sensing hole and a third optical sensing module, the another second sensing hole defined in the side surface, the third optical sensing module facing the second sensing holes defined in the side surface, the third optical sensing module configured for getting information about the second sensing hole defined in the side surface being blocked, and generating a blocking signal representing the white board eraser.

18. The writing method of claim 17, wherein the first signal output module, the second signal output module, the third signal output module, the first signal input module, and the second signal input module are one selected from the group consisting of ZigBee module, Bluetooth module, and Wi-Fi module.
